(19) United States
(12) Patent Application Publication
(10) Pub. No.: US 2016/0017501 A1
(43) Pub. Date: Jan. 21, 2016

(54) Corrosion Protection Material and Method for Protecting Aluminum Coatings

(71) Applicant: UNITED TECHNOLOGIES CORPORATION, Hartford, CT (US)

(72) Inventor: Christopher W Strock, Kennebunk, ME (US)

(73) Assignee: UNITED TECHNOLOGIES CORPORATION, Hartford, CT (US)

(21) Appl. No.: 14/774,300

(22) PCT Filed: Dec. 30, 2013
(86) PCT No.: PCT/US2013/078184

§ 371 Date: Sep. 10, 2015

Related U.S. Application Data
(60) Provisional application No. 61/781,593, filed on Mar. 14, 2013.

(51) Int. Cl. C23F 11/173; C23F 11/12; B05D 7/14

(52) U.S. Cl. CPC C23F 11/173; B05D 7/14; C23F 11/12

(57) ABSTRACT

A method for protecting porous aluminum coatings includes the steps of: providing an orsomil suspension; and rating the porous aluminum coating with said orsomil suspension. The porous aluminum coating may be thermally sprayed coating.

### BACKGROUND

The present disclosure is directed to an orsomil suspension which can be used to protect against corrosion in a porous aluminum coating and to a method for applying an orsomil (organically modified silicate) suspension to the porous aluminum coating.

Porous aluminum coatings are used for a wide variety of purposes. For example, abradable aluminum based coatings are applied to a casing surrounding a compressor section of a gas turbine engine. Due to the porosity of the aluminum coating and the environment in which the aluminum coating operates, internal corrosion can be significant. When present, the internal corrosion can weaken the coating and make it susceptible to fatigue cracking and spallation. The internal corrosion may be detected via white corrosion product on the surface of the coating and areas of coating swelling, lifting and flaking at mid thickness.

### SUMARY

In accordance with the present disclosure, there is provided a method for protecting porous aluminum coatings comprising the steps of: providing an orsomil suspension; and infiltrating the porous aluminum coating with the orsomil suspension.

In another and alternative embodiment, the orsomil suspension providing step comprises providing an orsomil suspension containing tetraethylorthosilicate, vinyltrimethoxysilane, 3-(trimethoxysilyl) propylmethacrylate, and hexyltrimethoxysilane.

In another and alternative embodiment, the orsomil suspension providing step comprises providing an orsomil suspension containing 11.2 ml tetraethylorthosilicate, 15.2 ml vinyltrimethoxysilane, 4.0 ml 3-(trimethoxysilyl) propylmethacrylate, and at least 10.7 vol % hexyltrimethoxysilane.

In another and alternative embodiment, the infiltrating step comprising wicking the orsomil suspension into cracks and gaps within the porous aluminum coating.

In another and alternative embodiment, the infiltrating step comprises using vacuum assisted infiltration to cause the orsomil suspension to penetrate the porous aluminum coating.

In another and alternative embodiment, the infiltrating step comprises using pressure assisted infiltration to cause the orsomil suspension to penetrate the porous aluminum coating.

In another and alternative embodiment, the method further comprises drying the infiltrated orsomil suspension to leave a solid film on aluminum surfaces within the porous aluminum coating.

In another and alternative embodiment, the method further comprises forming a solid film having a thickness in the range of from 2.0 to 15 microns on aluminum surfaces within the porous aluminum coating.

Further in accordance with the present disclosure, there is provided an orsomil suspension for providing corrosion resistance to a porous based aluminum coating, said orsomil suspension containing tetraethylorthosilicate, vinyltrimethoxysilane, 3-(trimethoxysilyl) propylmethacrylate, hexyltrimethoxysilane, and a solvent.

In another and alternative embodiment, the tetraethylorthosilicate is present in an amount of 11.2 ml, the vinyltrimethoxysilane is present in an amount of 15.2 ml, the 3-(trimethoxysilyl) propylmethacrylate is present in an amount of 4.0 ml., and the hexyltrimethoxysilane is present in an amount of at least 10.7 vol %.

In another and alternative embodiment, the solvent is selected from the group consisting of alcohol and water.

Still further in accordance with the present disclosure, there is provided a porous aluminum coating having aluminum surfaces within the coating and a solid film on the aluminum surfaces having a thickness in the range of from 2.0 to 15 microns.

In another and alternative embodiment, the coating is a thermally sprayed abradable coating.

Other details of the corrosion protection material and a method for protecting aluminum coatings are set forth in the following detailed description.

### DETAILED DESCRIPTION

In accordance with the present disclosure, an organically modified silane sol-gel coating (orsomil) is used as a treatment for porous aluminum coating to help prevent aqueous corrosion within the porosity of the coating.

The porous aluminum coating may be a thermally sprayed, abradable aluminum based coating which has been applied to a substrate formed from a metal alloy, such as a titanium alloy, a nickel alloy, or an iron alloy. For example, the coating could be formed from an aluminum/silicon material. The structure of the thermally sprayed aluminum based coating typically includes internal narrow cracks and gaps.

In accordance with the present disclosure, the orsomil sol-gel coating contains tetraethylorthosilicate, vinyltrimethoxysilane, 3-(trimethoxysilyl) propylmethacrylate, hexyltrimethoxysilane, and a solvent. The solvent may be selected from the group consisting of alcohol and water. In one non-limiting embodiment, the ormosil suspension used to form the coating consists of 11.2 ml tetraethylorthosilicate, 15.2 ml vinyltrimethoxysilane, 4.0 ml 3-(trimethoxysilyl) propylmethacrylate, at least 10.7 vol % hexyltrimethoxysilane, and the balance the solvent.

Once the ormosil suspension has been prepared, it is infiltrated into the porous aluminum coating. The infiltration step may be wicking the ormosil suspension into the narrow cracks and gaps within the thermal sprayed aluminum coating structure. Alternatively, the infiltration step may be vacuum or pressure assisted infiltration of the ormosil suspension into the aforesaid cracks and gaps within the aluminum coating structure.

After infiltration, the solvent is evaporated off using any suitable drying technique. Once the solvent has evaporated off, there is a solid film left on the aluminum surfaces within the aluminum coating. The solid film has a thickness of from 2.0 microns to 15 microns in thickness.

The method described herein provides an improved resistance to cracking and hydrophobic characteristics that help protect the aluminum surfaces and reduce the wicking of water into the coating. This helps to improve coating durability. The abradability of the coating is substantially conserved due to the small thickness of the surface treatment. Additionally, the mechanical properties of the aluminum coating are preserved and corrosion resistance is provided.

There has been provided a corrosion protection material and a method for protecting aluminum coatings. While the corrosion protection material and the method for protecting aluminum coatings have been disclosed in the context of specific embodiments thereof, other unforeseen alternatives, modifications, and variations may become apparent to those skilled in the art having read the foregoing description. Accordingly, it is intended to embrace those alternatives, modifications, and variations as fall within the broad scope of the appended claims.

What is claimed is:

1. A method for protecting porous aluminum coatings comprising the steps of:
providing an orsomil suspension; and
infiltrating said porous aluminum coating with said orsomil suspension.

2. The method of claim 1, wherein said orsomil suspension providing step comprises providing an orsomil suspension containing tetraethylorthosilicate, vinyltrimethoxysilane, 3-(trimethoxysilyl) propylmethacrylate, and hexyltrimethoxysilane.

3. The method of claim 1, wherein said orsomil suspension providing step comprises providing an orsomil suspension containing 11.2 ml tetraethylorthosilicate, 15.2 ml vinyltrimethoxysilane, 4.0 ml 3-(trimethoxysilyl) propylmethacrylate, and at least 10.7 vol % hexyltrimethoxysilane.

4. The method of claim 1, wherein said infiltrating step comprising wicking said orsomil suspension into cracks and gaps within the porous aluminum coating.

5. The method of claim 1, wherein said infiltrating step comprises using vacuum assisted infiltration to cause said orsomil suspension to penetrate the porous aluminum coating.

6. The method of claim 1, wherein said infiltrating step comprises using pressure assisted infiltration to cause said orsomil suspension to penetrate the porous aluminum coating.

7. The method of claim 1, further comprising drying said infiltrated orsomil suspension to leave a solid film on aluminum surfaces within said porous aluminum coating.

8. The method of claim 1, further comprising forming a solid film having a thickness in the range of from 2.0 to 15 microns on aluminum surfaces within said porous aluminum coating.

9. An orsomil suspension for providing corrosion resistance to a porous based aluminum coating, said orsomil suspension containing tetraethylorthosilicate, vinyltrimethoxysilane, 3-(trimethoxysilyl) propylmethacrylate, hexyltrimethoxysilane, and a solvent.

10. The orsomil suspension of claim 9, wherein said tetraethylorthosilicate is present in an amount of 11.2 ml, said vinyltrimethoxysilane is present in an amount of 15.2 ml, said 3-(trimethoxysilyl) propylmethacrylate is present in an amount of 4.0 ml., and said hexyltrimethoxysilane is present in an amount of at least 10.7 vol %.

11. The orsomil suspension of claim 9, wherein said solvent is selected from the group consisting of alcohol or water.

12. A porous aluminum coating having aluminum surfaces within the coating and a solid film on the aluminum surfaces having a thickness in the range of from 2.0 to 15 microns.

13. The porous aluminum coating of claim 12, wherein said coating is a thermally sprayed abradable coating.
